(19) United States
(12) Patent Application Publication
(10) Pub. No.: US 2026/0189952 A1
(43) Pub. Date: Jul. 2, 2026

(54) SCHEDULING RESTRICTION AND MEASUREMENT IN NON-TERRESTRIAL NETWORKS

(71) Applicant: Apple Inc., Cupertino, CA (US)

(72) Inventors: Jie Cui, San Jose, CA (US); Yang Tang, San Jose, CA (US); Qiming Li, Beijing (CN); Dawei Zhang, Cupertino, CA (US); Chunxuan Ye, San Diego, CA (US); Haitong Sun, Cupertino, CA (US)

(21) Appl. No.: 18/847,956

(22) PCT Filed: Sep. 27, 2023
(86) PCT No.: PCT/CN2023/122064

§ 371 Date: Sep. 17, 2024

(30) Foreign Application Priority Data
Sep. 27, 2023 (WO) PCT/CN2023/122064

(51) Int. Cl. H04W 24/10; H04W 16/28; H04W 56/00; H04W 84/06

(52) U.S. Cl. CPC H04W 24/10; H04W 16/28; H04W 56/001; H04W 84/06

(57) ABSTRACT

A user equipment (UE) includes a transceiver, an antenna that is mechanically steerable by the UE and coupled with the transceiver, and a processor. The processor is configured to cause the UE to receive, via the transceiver, control signaling indicating a first measurement gap configuration for mechanical beam steering for the antenna different from a second measurement gap configuration associated with electronic beam steering, and communicate, in a first direction, with a first non-terrestrial network device on a first radio frequency spectrum band. The processor further causes the UE to switch, based on the first measurement gap configuration, the antenna toward a second direction, and perform, according to the first measurement gap configuration and while mechanically pointing toward the second direction, measurements of reference signals received from a second non-terrestrial network device on a second radio frequency spectrum band.

### TECHNICAL FIELD

This application relates generally to wireless communication systems, including systems, apparatuses, and methods for scheduling restriction and measurement in non-terrestrial networks (NTNs).

### BACKGROUND

Wireless mobile communication technology uses various standards and protocols to transmit data between a network device (e.g., a base station, a radio head, etc.) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example signal diagram for wireless communications, according to one or more aspects described herein.

FIG. 3 shows an example process flow, according to one or more aspects described herein.

FIG. 4 shows an example process flow, according to one or more aspects described herein.

FIG. 5 shows an example signal diagram for wireless communications, according to one or more aspects described herein.

FIG. 6 shows another example method of wireless communication by a UE, according to one or more aspects described herein.

FIG. 7 shows another example method of wireless communication by a network device, according to one or more aspects described herein.

FIG. 8 illustrates an example architecture of a wireless communication system, according to embodiments described herein.

FIG. 9 illustrates an example system for performing signaling between a wireless device and a network device, according to embodiments described herein.

### DETAILED DESCRIPTION

Various embodiments are described with regard to a user equipment (UE), a non-terrestrial network (NTN) device, a network device (e.g., a terrestrial network (TN) device). However, reference to a UE is merely provided for illustrative purposes. The example embodiments may be utilized with any electronic component that may establish a connection to a network and is configured with the hardware, software, and/or firmware to exchange information and data with a network. Therefore, the UE, the NTN device, and the network device as described herein is used to represent any appropriate electronic device.

In addition to utilizing TN devices (terrestrial base stations such as an eNB or a gNB), cellular networks may use NTN devices. NTN devices may include various network devices operating above the surface of the earth that communication resources to UEs (e.g., terrestrial, airborne, or on water) with a particular coverage area served by the NTN device. For example, an appropriately configured UE that lacks coverage from a TN device may instead communicate with an NTN device. In some deployments, NTN devices are stationary relative to features on the ground, but other NTN devices move relative to the ground. Examples of stationary NTN devices include satellites in geosynchronous orbit (GSO or GEO). Examples of moving or NTN devices includes include satellites in low earth orbit (LEO) or medium earth orbit (MEO), satellites in a polar orbit, high-altitude platforms (HAPS), or drones. UEs may operate on the surface of the earth but may also operate above the surface or on water, for example on or as part of an aircraft or ship.

Network devices (whether NTN devices or TN devices) and UEs may move relative to each other during connectivity. Additionally, certain communication types (e.g., UE to NTN device communications, or terrestrially using millimeter wave communications) may benefit from using beamforming to shape the direction of electromagnetic radiation used for communication to increase distance and signal power in a particular direction. As such, UEs, including UEs that communicate with NTN devices, may use mechanical beam steering for directional antennas (e.g., parabolic antennas) or electronic beam steering for antenna arrays (e.g., grids of phased antenna array elements) to direct the energy of transmitted electromagnetic radiation or improve the reception of received electromagnetic radiation.

A UE in communication with a NTN device as a serving cell may use mechanical beam steering to change the antenna angle (e.g., pointing), During the change of antenna angle (e.g., before the UE returns the antenna angle to the original position), the UE may not be able to receive any channel or signal from the serving cell. When the UE is monitoring a neighboring serving cell of a neighboring NTN device (e.g., a target serving cell of a target NTN device), the UE may need to stop all connection with the serving cell during the beam steering switching period and the measurement period, even if the target cell of the target NTN is on or using a same frequency carrier as the serving cell of the serving NTN device.

According to current approaches, a scheduling restriction for the serving cell of the serving NTN device may not appropriately take into account challenges introduced by mechanical beam steering. For example, current approaches assume the used of electronic beam steering, which may be able to switch between beams for measurement relatively faster than mechanical beam steering. In particular, channel state information reference signal (CSI-RS)-based layer 1 (L1) measurements may not work if the mechanical beam sweeping time is greater than a cyclic prefix (CP) length, which is the time duration provided to switch between beams for electronic beam sweeping. For example, CSI-RS measurement occasions (opportunities) may be configured to be in consecutive symbols. The time needed for an antenna that is mechanically steerable to change beams (e.g., in a beam sweep) may be as long a one or two symbols. As such, a different approach is needed for a UE to determine which measurement occasions (e.g., CSI-RS measurement occasions) that the UE is to use. In some embodiments, a mechanical beam sweeping time is compared (checked) against a time interval between CSI-RS symbols (measurement occasions) to determine CSI-RS symbols that the UE will measure. In some embodiments, the CSI-RS symbols may be in a set of consecutive symbols that occur periodically. The UE may measure a first CSI-RS symbol in a first set of CSI-RS symbols, a second CSI-RS symbol in a later, second set of CSI-RS symbols, and so on, to measure each CSI-RS symbol. In such case, the UE may refrain from performing a receive beam sweep (e.g., electronic beam steering) following the use of mechanical beam steering to steer the antenna of the UE to each CSI-RS measurement occasion.

In light of the above, and other described challenges, improved UE scheduling restriction and measurement techniques in NTNs are desirable. As further described herein, a UE includes a transceiver, an antenna that is mechanically steerable by the UE and coupled with the transceiver, and a processor. In one or more embodiments, the processor is configured to cause the UE to receive, via the transceiver, control signaling indicating a first measurement gap configuration for mechanical beam steering for the antenna different from a second measurement gap configuration associated with electronic beam steering, and communicate, in a first direction, with a first non-terrestrial network device on a first radio frequency spectrum band. The processor further causes the UE to switch, based on the first measurement gap configuration, the antenna toward a second direction, and perform, according to the first measurement gap configuration and while mechanically pointing toward the second direction, measurements of reference signals received from a second non-terrestrial network device on a second radio frequency spectrum band.

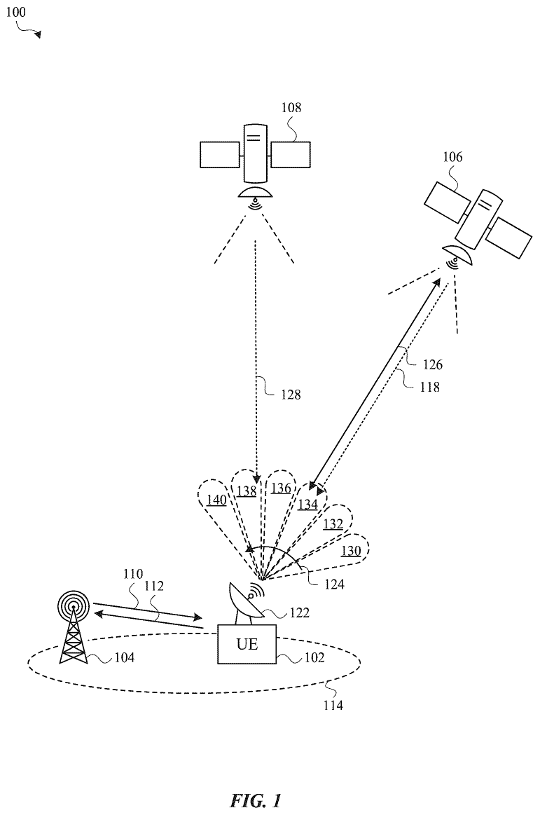

FIG. 1 shows an example wireless communication system 100, according to one or more aspects described herein. In one or more embodiments, wireless communication system 100, supports one or more aspects of scheduling restriction and measurement in NTNs, as further described herein.

Wireless communication system 100 includes a UE 102, base station 104, NTN device 106, and NTN device 108. One or more UEs including the UE 102 may be being served by (e.g., has an established radio resource control (RRC) connection with) the NTN device 106 via communication link 126. Coverage area 114 (e.g., a cell or serving cell) is the service area for the RF spectrum band utilized by NTN device 106. In one or more embodiments, UE 102 may have previously established a connection with base station 104 (e.g., a terrestrial network (TN) device), and established a downlink connection 110 and/or uplink connection 112. NTN device 108 may be a neighboring NTN device to UE 102, for example having a coverage area that at least partially overlaps with coverage area 114 in some cases.

The UE 102, when pointed toward a first direction (e.g., toward NTN device 106), has a current receive beam, the beam 134 that is capable of receiving signals transmitted by or transmitting signals to NTN device 106 (e.g., beam angles associated with beam 134 are sufficient to cover the NTN device 106), including signals 118 (e.g., reference signals, for example CSI-RS or synchronization signal blocks (SSBs)). The UE 102, when pointed toward a second direction (e.g., toward NTN device 108), has a beam 138 that is capable of receiving the signals 128 (e.g., reference signals, for example CSI-RS or SSB) transmitted by NTN device 108 (e.g., beam angles for beam 138 are sufficient to cover the NTN device 108).

In one or more embodiments, UE 102 is capable of mechanical beam steering. In some embodiments, such mechanical beam steering includes the ability of the UE 102 to mechanically move (reorient, shift, steer) one or more antennas 122 of the UE 102 mechanically to point in various directions or range of directions. In some embodiments, UE 102 can perform a beam sweep 124, switching the point (e.g., mechanically steering) the antenna 122 across a set of beams, including for example one or more of beam 130, beam 132, beam 134, beam 136, beam 138, and beam 140. During beam sweep 124, the antenna 122 may remain at a particular position (pointing toward a direction) for a time duration, then moving to a different position during a switching time for the mechanical beam steering of the antenna 122. A beam sweep may include mechanically steering the antenna 122 to point in all or a subset of potential or possible directions for the antenna 122, and may skip directions, or otherwise point in various direction out of order.

In one or more embodiments, UE 102 is capable of electronic beam steering. In some embodiments, UE 102 is capable of performing electronic beam steering in addition to mechanical beam steering. In other embodiments, UE 102 is capable of performing electronic beam steering, but not mechanical beam steering. In some embodiments, UE 102 is capable of performing electronic beam steering at a same time as mechanical beam steering. In other embodiments, UE 102 is capable of performing one of electronic beam steering or mechanical beam steering at a time. As used herein, electronic beam steering refers, without limitation, to the ability of a UE (e.g., UE 102) to performing beamforming, beam shaping, or other multiple antenna or multiple antenna-element techniques that control, direct, or otherwise shape electromagnetic energy radiated from the UE 102 in different directions and with different magnitudes or amplitudes. For example, UE 102 may be able to perform the beam sweep 124 across the set of beams, including for example one or more of beam 130, beam 132, beam 134, beam 136, beam 138, and beam 140, as further described above. In some embodiments, mechanical beam steering may be used for coarse beam steering (e.g., to beam 130), and electronic beam steering may be used for finer beam steering (e.g., to steer to multiple narrower beams with beam 130). Electronic beam steering also refers to the UE 102 adjusting antennas or elements of antennas to increase or decrease the ability to receive electromagnetic radiation from a particular direction. Such reception beamforming may be referred to as a “receive beam,” as opposed to transmit beamforming using “transmit beams.”

As further described herein, in one or more embodiments, the UE 102 assumes a scheduling restriction related to mechanical beam steering different from a scheduling restriction that the UE assumes for electronic beam steering. Additionally, in some embodiments, the UE 102 can perform a beam sweeping for reference signal measurement (e.g., CSI-RS based L1 measurements) that depends on whether the UE 102 is using mechanical beam steering (e.g., the beam sweeping operates differently for mechanical beam steering than the UE 102 is only using electronic beam steering). In some embodiments, receive beam sweeping (e.g., performed using electronic beam steering) is disabled as long as the UE 102 uses mechanical beam steering. In some embodiments, the UE 102 can use mechanical beam sweeping with a longer beam switching delay (e.g., longer than the beam sweeping delay associated with electronic beam steering).

In one or more embodiments, the UE 102 receives control signaling indicating a measurement timing configuration (e.g., a SMTC) from the network (e.g., via base station 104 or NTN device 106). In some embodiments, this control signaling is radio resource control (RRC) signaling (e.g., one or more configuration parameters and/or information elements). The measurement timing configuration can be for the UE 102 to perform one or more measurements of signals from neighboring NTN devices (e.g., NIN device 108, but may also include cells of NTN device 106) during a set of measurement time windows. The UE may then communicate with the NTN device 106, via the antenna 122 that is mechanically pointing toward a first direction (e.g., beam 134), on a first radio frequency spectrum band. During communication, the UE 102 does not expect to communicate with the first non-terrestrial network device during a restriction time window within the set of measurement time windows. In one or more embodiments, the restriction time window includes a set of time resources that are based at least in part on time resources for the signals that are indicated by the measurement timing configuration and one or more symbols for a switching time for mechanical beam steering of the antenna 122. The UE 102 may then perform, according to the measurement timing configuration and while the antenna 122 is mechanically pointing toward at least a second direction (e.g., toward NTN device 108 at or using beam 138), one or more measurements of the signals (e.g., signals 128) received via the antenna 122 of the UE 102.

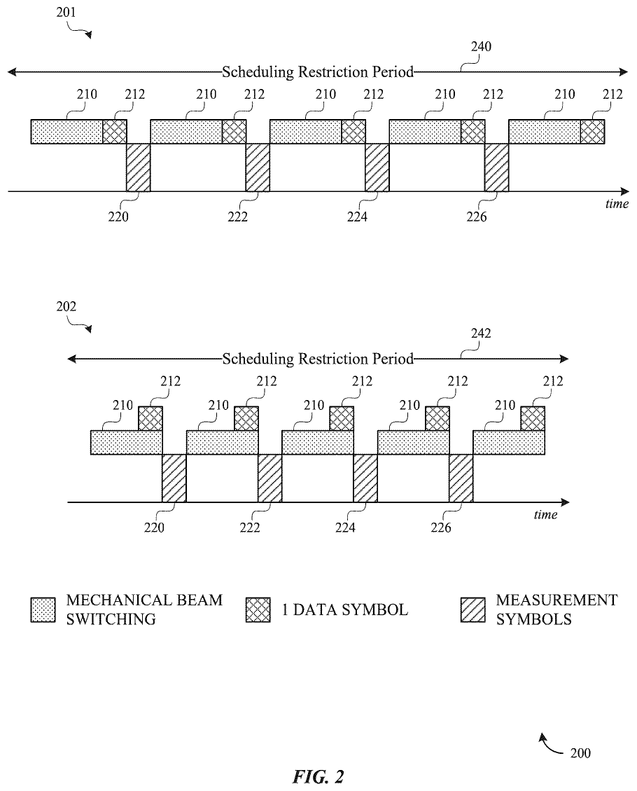

FIG. 2 shows an example signal diagram 200 for wireless communications, according to one or more aspects described herein. In one or more embodiments, signal diagram 200, supports one or more aspects of scheduling restriction and measurement in NTNs, as further described herein. In some cases, the UE may be the UE 102, wireless device 902, or one of the other UEs described herein. In some cases, the network device may be the NTN device 106, NTN device 108, base station 104, network device 920, NTN device 940, or one of the other network devices described herein.

Signal diagram 200 includes a signal diagram 201, according to some embodiments, and a signal diagram 202, according to some embodiments. Signal diagram 201 shows a scheduling restriction period 240 and signal diagram 202 shows a scheduling restriction period 242, each of which have a first time duration 210 for mechanical beam steering (which may also be referred to as switching, or mechanical beam switching), a second time duration 212 of one data symbol (e.g., a single OFDMA symbol period, or a single SC-FDMA symbol period), and a third time duration for measurement symbols. The measurement symbols include a first measurement symbol 220, a second measurement symbol 222, a third measurement symbol 224, and a fourth measurement symbol 226. Each measurement symbol may correspond to a different direction.

In one or more embodiments, signal diagram 201 can be for reference signal received power (RSRP) or signal-to-interference noise ratio (SINR) measurements on an intra-frequency NTN cell. These measurements may be for SSBs from NTN devices (e.g., the measurements are SS-RSRP and SS-SINR measurements). In some embodiments, such measurements may be for carrier frequencies above about 10 GHz. As shown in signal diagram 201, the scheduling restriction period 240 may be structured such that the scheduling restriction period 240 includes the SSB symbols to be measured, and (1 data symbol+mechanical beam steering switching delay) before each consecutive SSB symbols to be measured and (1 data symbol+mechanical beam steering switching delay) after each consecutive SSB symbols to be measured within the scheduling restriction period 240 (e.g., the SMTC window duration). That is, scheduling restriction period 240 includes the SSB symbols to be measured (e.g., the first measurement symbol 220, the second measurement symbol 222, the third measurement symbol 224, and the fourth measurement symbol 226), each instance of the first time duration 210, and each instance of the second time duration 212. Although shown as discrete time duration, and in an order of the first time duration 210, followed by the second time duration 212, the time durations may be combined or in another order, consistent with the disclosure herein.

In one or more embodiments, signal diagram 201 can be for reference signal received quality (RSRQ) measurements on an intra-frequency NTN cell. These measurements may be for SSBs from NTN devices (e.g., the measurements are SS-RSRP and SS-SINR measurements). In some embodiments, such measurements may be for carrier frequencies above about 10 GHz. As shown in signal diagram 201, the scheduling restriction period 240 may be structured such that the scheduling restriction period 240 includes SSB symbols to be measured, RSSI measurement symbols, and (1 data symbol+mechanical beam steering switching delay) before each consecutive SSB to be measured/RSSI symbols and (1 data symbol+mechanical beam steering switching delay) after each consecutive SSB to be measured/RSSI symbols within SMTC window duration. That is, scheduling restriction period 240 includes the SSB symbols and/or RSSI symbols to be measured (e.g., the first measurement symbol 220, the second measurement symbol 222, the third measurement symbol 224, and the fourth measurement symbol 226), each instance of the first time duration 210, and each instance of the second time duration 212. The measurement symbols may be for SSBs in some cases (e.g., at certain times), and for RSSI in other cases (e.g., at other times) within a same scheduling restriction period 204.

In one or more embodiments, signal diagram 202 can be for RSRP, SINR, and/or RSRQ measurements on an intra-frequency NTN cell, similar to as described with reference to signal diagram 201. However, rather than first time duration 210 and second time duration 212 configured to be sequential, in scheduling restriction period 242, the time duration before, between, and after measurement symbols is the maximum (e.g., the longer time duration) of the first time duration 210 for the mechanical beam steering and second time duration 212 for the one data symbol.

In one or more embodiments, signal diagram 202 can be for reference signal received quality (RSRQ) measurements on an intra-frequency NTN cell. These measurements may be for SSBs from NTN devices (e.g., the measurements are SS-RSRP and SS-SINR measurements). In some embodiments, such measurements may be for carrier frequencies above about 10 GHz. As shown in signal diagram 202, the scheduling restriction period 242 may be structured such that the scheduling restriction period 242 includes SSB symbols to be measured, RSSI measurement symbols, and (1 data symbol+mechanical beam steering switching delay) before each consecutive SSB to be measured/RSSI symbols and (1 data symbol+mechanical beam steering switching delay) after each consecutive SSB to be measured/RSSI symbols within SMTC window duration. That is, scheduling restriction period 242 includes the SSB symbols and/or RSSI symbols to be measured (e.g., the first measurement symbol 220, the second measurement symbol 222, the third measurement symbol 224, and the fourth measurement symbol 226), each instance of the first time duration 210, and each instance of the second time duration 212. The measurement symbols are for SSBs in some cases, and for RSSI in other cases.

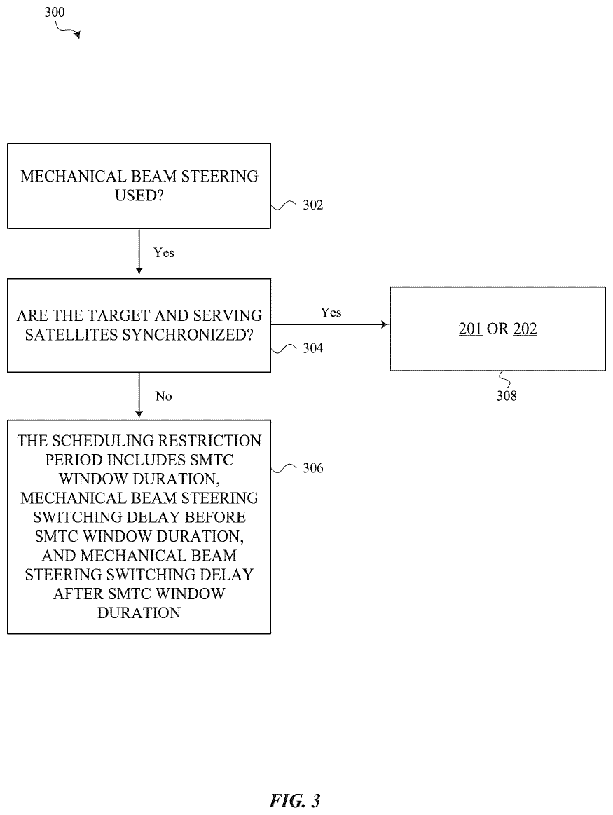

FIG. 3 shows an example process flow 300 for wireless communications, for example by a UE and/or network device when mechanical beam steering is used by a UE, according to one or more aspects described herein. In one or more embodiments, process flow 300, supports one or more aspects of scheduling restriction and measurement in NTNs, as further described herein. In some cases, the UE may be the UE 102, wireless device 902, or one of the other UEs described herein. In some cases, the network device may be the NTN device 106, NTN device 108, base station 104, network device 920, NTN device 940, or one of the other network devices described herein.

At 302, the process flow 300 applies if the UE uses mechanical beam steering.

At 304, the target cell for measurement (e.g., a target NTN device) and the current serving cell for the UE 102 are synchronized, then the UE proceeds to select the appropriate scheduling restriction period from one of signal diagram 201 or signal diagram 202.

The process flow 300 proceeds to 306 if the target cell for measurement and the current serving cell for the UE 102 are not synchronized. At 306, the scheduling restriction period due to SS-RSRP or SS-SINR or RSSI measurement on an intra-frequency NTN cell (e.g., using a carrier frequency above 10 GHz) includes the SMTC window duration, a mechanical beam steering switching delay before the SMTC window duration, and a mechanical beam steering switching delay after the SMTC window duration,

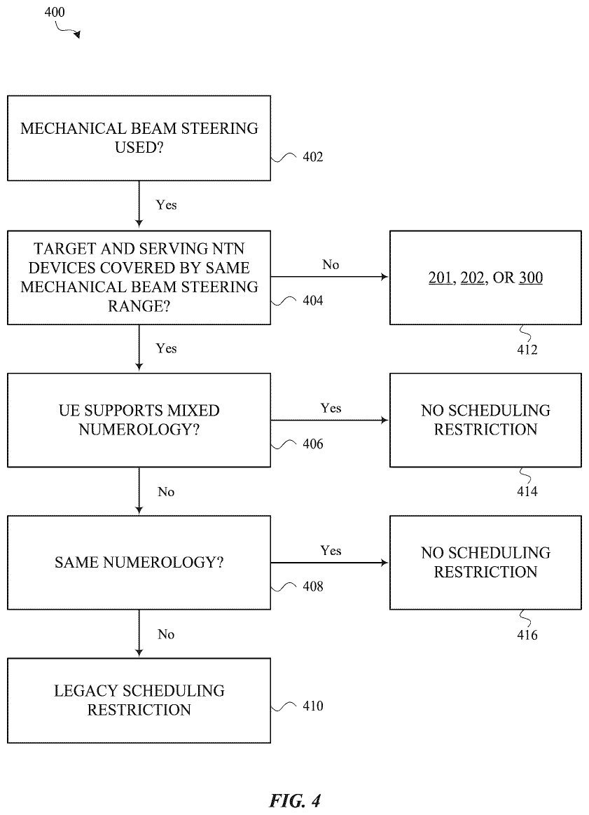

FIG. 4 shows an example process flow 400 for wireless communications, for example by a UE and/or network device, according to one or more aspects described herein. In one or more embodiments, process flow 400, supports one or more aspects of scheduling restriction and measurement in NTNs, as further described herein. In some cases, the UE may be the UE 102, wireless device 902, or one of the other UEs described herein. In some cases, the network device may be the NTN device 106, NTN device 108, base station 104, network device 920, NTN device 940, or one of the other network devices described herein.

At 402, the process flow 300 applies if the UE uses mechanical beam steering.

At 404, if the target NTN device and serving NTN device are covered by a same mechanical beam steering range, the process flow 400 proceeds to 406. If the target NIN device and serving NTN device are covered by a different mechanical beam steering range, then one of process flow 300 applies, or the UE proceeds to select the appropriate scheduling restriction period from one of signal diagram 201 or signal diagram 202, as further described herein, at 412.

At 406, if the UE 102 supports a mixed numerology, then no scheduling restriction applies at 414. If the UE 102 does not support a mixed numerology, then the process flow 400 proceeds to 408.

At 406, if the UE 102 does not support a mixed numerology, but uses a same numerology, then no scheduling restriction applies at 416. If the UE 102 does not use a same numerology, then the process flow 400 proceeds to 410, and the UE 102 uses a legacy scheduling restriction is applied by UE 102.

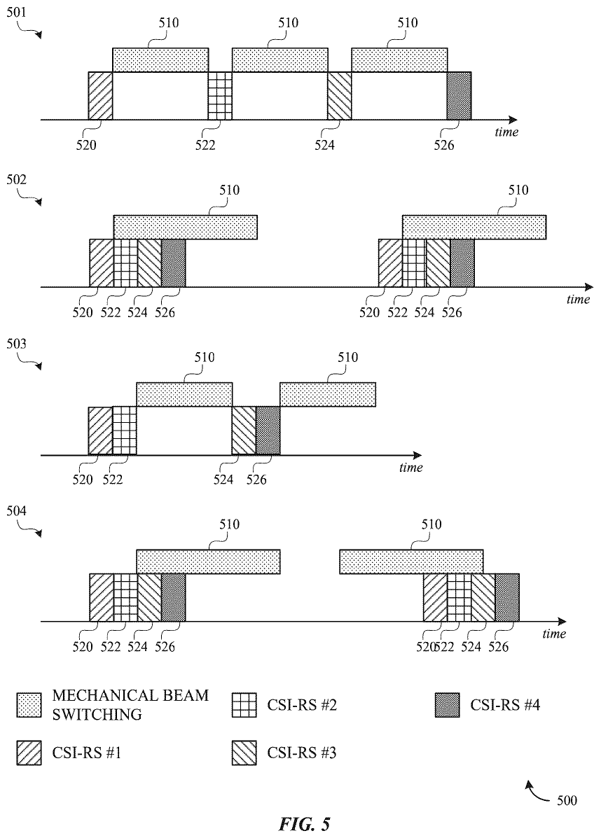

FIG. 5 shows a signal diagram 500 for wireless communications, according to one or more aspects described herein. In one or more embodiments, signal diagram 500, supports one or more aspects of scheduling restriction and measurement in NTNs, as further described herein. In some cases, the UE may be the UE 102, wireless device 902, or one of the other UEs described herein. In some cases, the network device may be the NIN device 106, NTN device 108, base station 104, network device 920, NTN device 940, or one of the other network devices described herein. In one or more embodiments, signal diagram 500 applies to UE 102 that is capable of using or is using mechanical beam steering.

Signal diagram 500 includes a signal diagram 501 according to some embodiments, a signal diagram 502 according to some embodiments, a signal diagram 503 according to some embodiments, and a signal diagram 504 according to some embodiments. Each signal diagram shows a mechanical beam switching time 510, a first CSI-RS resource 520, a second CSI-RS resource 522, a third CSI-RS resource 524, and a fourth CSI-RS resource 526. The first CSI-RS resource 520, the second CSI-RS resource 522, the third CSI-RS resource 524, and the fourth CSI-RS resource 526 may be or be referred to as a CSI-RS resource set. Each resource may by one or more symbol periods, and correspond to a different direction.

In one or more embodiments, if UE 102 supports mechanical beam steering, and this mechanical beam steering is under using (e.g., unused), then a receive beam sweeping (e.g., using electronic beam steering) is not applied at UE 102. In some embodiments, the receive beam sweeping factor may be assumed to be one for L1 measurements, for example, regardless of whether repetition is ON or OFF in a CSI-RS resource set configuration.

In one or more embodiments, if UE 102 supports mechanical beam steering to perform a receive beam sweep, then the Rx beam sweeping factor is determined by the CSI-RS resource number (e.g., a quantity of resources) in the resource set, the mechanical beam steering switching time, and the receive beam number to sweep (e.g., a quantity of resources to sweep). In some embodiments, the beam sweeping factor (N) is determined according to the formula:

N=ceil(maxNumberRxBeam/effective-resource-num-per-set)

In some embodiments, the effective resource number per set (e.g., per CSI-RS resource set) (effective-resource-num-per-set) is determined by the CSI-RS resource number in the resource set and the mechanical beam steering switching time. Signal diagram 501 shows a first example, and signal diagram 502 shows a second example.

According to the example shown in signal diagram 501, the time interval between each two CSI-RS resources are greater than the mechanical beam steering switching time, thus effective-resource-num-per-set is four.

According to the example shown in signal diagram 502, the time interval between each two CSI-RS resources (e.g., between the first CSI-RS resource 520 and the second CSI-RS resource 522) are smaller than the mechanical beam steering switching time (CSI-RS resources in resource set are back-to-back configured), and thus the effective-resource-num-per-set is one.

In one or more embodiments, if UE 102 supports both mechanical beam steering and electronic beam steering to perform a receive beam sweep, then the receive beam sweeping factor is determined by the CSI-RS resource number in the resource set, the mechanical beam steering switching time, the receive beam number to sweep by a mechanical method (e.g., by mechanical beam steering), and the receive beam number to sweep by an electronic method (e.g., by electronic beam steering). Here, the beam sweeping factor is determined according to the formula:

N=ceil(maxNumberRxBeam/effective-resource-num-per-set)

In some embodiments, the effective resource number per set (e.g., per CSI-RS resource set) (effective-resource-num-per-set) is determined by the CSI-RS resource number in the resource set, the receive beam number to sweep by mechanical method, and the receive beam number to sweep by electronic method. Signal diagram 503 shows a first example, and signal diagram 504 shows a second example.

According to the example shown in signal diagram 503, the receive beam number to sweep by electronic method is two, and CSI-RS resource {#1 and #2} (the first CSI-RS resource 520 and the second CSI-RS resource 522) and {#3 and #4} (the third CSI-RS resource 524 and the fourth CSI-RS resource 526) can be used for electronic beam sweeping. The time interval between CSI-RS resource #2 and #3 (the second CSI-RS resource 522 and the third CSI-RS resource 524) is greater than the mechanical beam steering switching time, and the effective-resource-num-per-set is four.

According to the example shown in signal diagram 504, the receive beam number to sweep by electronic method is two, and CSI-RS resource {#1 and #2} (the first CSI-RS resource 520 and the second CSI-RS resource 522) and {#3 and #4} (the third CSI-RS resource 524 and the fourth CSI-RS resource 526) can be used for electronic beam sweeping, but the time interval between each two CSI-RS resources are smaller than the mechanical beam steering switching time (CSI-RS resources in resource set are back-to-back configured), and the effective-resource-num-per-set is two.

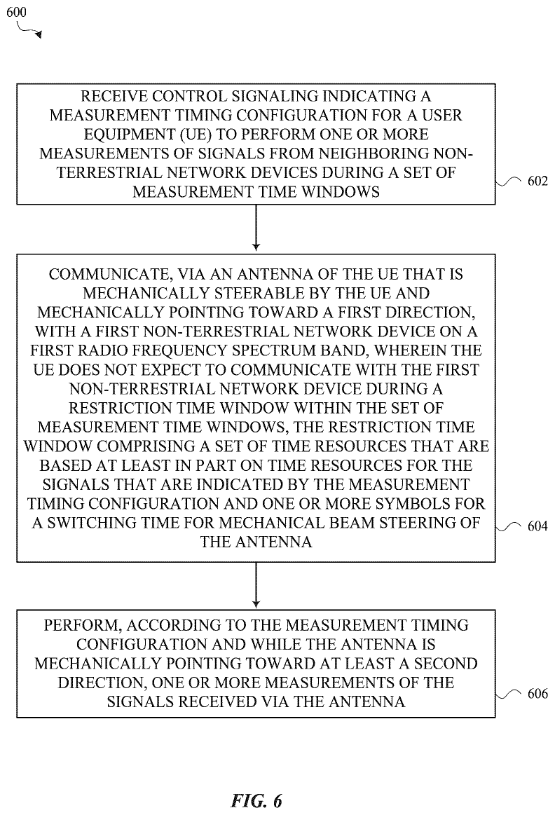

FIG. 6 shows an example method 600 of wireless communication by a UE. In one or more embodiments, method 600, supports one or more aspects of scheduling restriction and measurement in NTNs, as further described herein. In some cases, the UE may be the UE 102, wireless device 902, or one of the other UEs described herein. The method 600 may be performed using a processor, a transceiver (or a main radio), or other components of the UE.

At 602, the method 600 includes receiving control signaling indicating a measurement timing configuration for the UE to perform one or more measurements of signals from neighboring non-terrestrial network devices during a set of measurement time windows.

At 604, the method 600 includes communicating, via an antenna of the UE that is mechanically steerable by the UE and mechanically pointing toward a first direction, with a first non-terrestrial network device on a first radio frequency spectrum band, where the UE does not expect to communicate with the first non-terrestrial network device during a restriction time window within the set of measurement time windows, the restriction time window comprising a set of time resources that are based at least in part on time resources for the signals that are indicated by the measurement timing configuration and one or more symbols for a switching time for mechanical beam steering of the antenna.

At 606, the method 600 includes performing, according to the measurement timing configuration and while the antenna is mechanically pointing toward at least a second direction, one or more measurements of the signals received via the antenna.

The method 600 may be variously embodied, extended, or adapted, as described in the following paragraphs and elsewhere in this description.

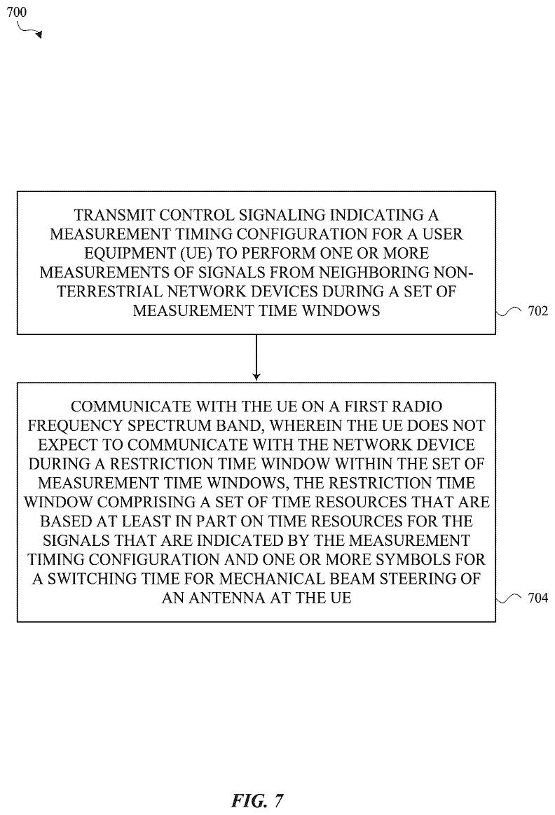

FIG. 7 shows an example method 700 of wireless communication by a network device. In one or more embodiments, method 700, supports one or more aspects of scheduling restriction and measurement in NTNs, as further described herein. In some cases, the network device may be the base station 104, network device 920, or one of the other network devices described herein. The method 700 may be performed using a processor, a transceiver (or main radio), or other components of the network device.

At 702, the method 700 includes transmitting control signaling indicating a measurement timing configuration for a UE to perform one or more measurements of signals from neighboring non-terrestrial network devices during a set of measurement time windows.

At 704, the method 700 includes communicating with the UE on a first radio frequency spectrum band, where the UE does not expect to communicate with the network device during a restriction time window within the set of measurement time windows, the restriction time window comprising a set of time resources that are based at least in part on time resources for the signals that are indicated by the measurement timing configuration and one or more symbols for a switching time for mechanical beam steering of an antenna at the UE.

Embodiments contemplated herein include one or more non-transitory computer-readable media storing instructions to cause an electronic device, upon execution of the instructions by one or more processors of the electronic device, to perform one or more elements of the method 600 or 700. In the context of method 600, this non-transitory computer-readable media may be, for example, a memory of a UE (such as a memory 906 of a wireless device 902 that is a UE, as described herein). In the context of method 700, this non-transitory computer-readable media may be, for example, a memory of a network device (such as a memory 924 of a network device 920, as described herein).

Embodiments contemplated herein include an apparatus having logic, modules, or circuitry to perform one or more elements of the method 600 or 700. In the context of method 600, this apparatus may be, for example, an apparatus of a UE (such as a wireless device 902 that is a UE). In the context of method 700, this apparatus may be, for example, an apparatus of a network device (such as a network device 920, as described herein).

Embodiments contemplated herein include an apparatus having one or more processors and one or more computer-readable media, using or storing instructions that, when executed by the one or more processors, cause the one or more processors to perform one or more elements of the method 600 or 700. In the context of method 600, this apparatus may be, for example, an apparatus of a UE (such as a wireless device 902 that is a UE, as described herein). In the context of the method 700, this apparatus may be, for example, an apparatus of a network device (such as a network device 920, as described herein).

Embodiments contemplated herein include a signal as described in or related to one or more elements of the method 600 or 700.

Embodiments contemplated herein include a computer program or computer program product having instructions, wherein execution of the program by a processor causes the processor to carry out one or more elements of the method 600 or 700. In the context of method 600, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 700, the processor may be a processor of a network device (such as a processor(s) 922 of a network device 920, as described herein), and the instructions may be, for example, located in the processor and/or on a memory of the network device (such as a memory 924 of a network device 920, as described herein),

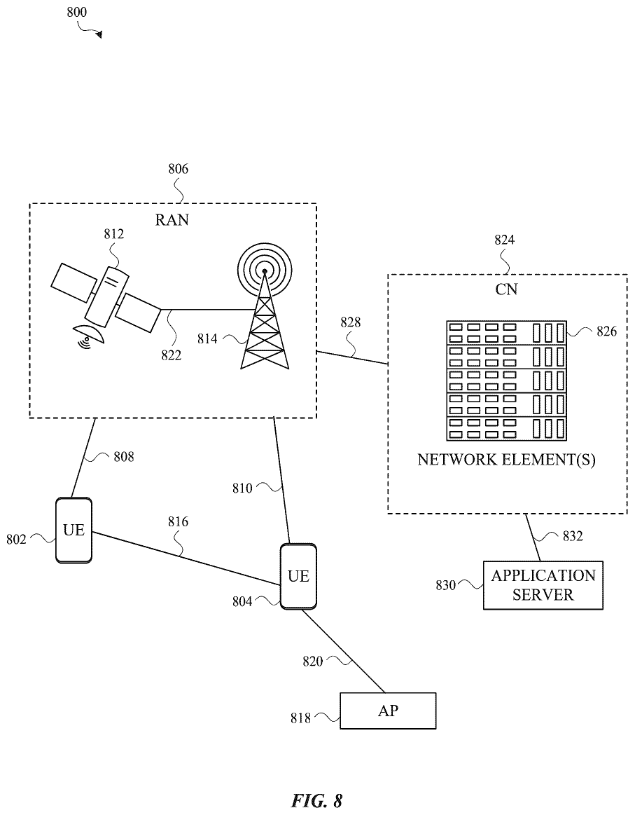

FIG. 8 illustrates an example architecture of a wireless communication system, according to embodiments described herein. The following description is provided for an example wireless communication system 800 that operates in conjunction with the LTE system standards or specifications and/or 5G or NR system standards or specifications, as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks) but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more network devices, such as base station 812 and base station 814, that enable the connection 808 and connection 810.

In this example, the connection 808 and connection 810 are air interfaces to enable such communicative coupling and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more network devices of a RAN (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more network devices of a RAN (e.g., two or more gNBs and the like) that connect to the 5GC, between a base station 812 (e.g., a gNB) connecting to the 5GC and an eNB, and/or between two eNBs connecting to the 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

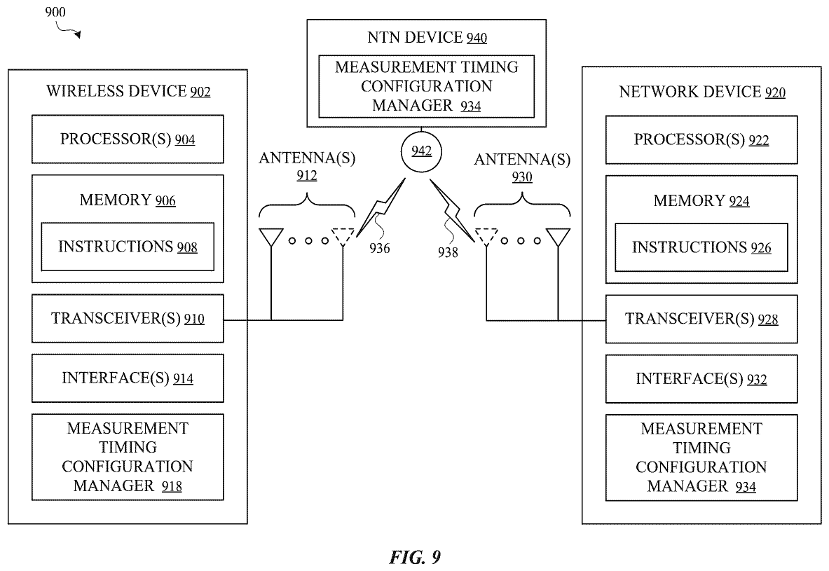

FIG. 9 illustrates an example system 900 for performing the signaling 938 between a wireless device 902 and a network device 920, according to embodiments described herein. The system 900 may be a portion of a wireless communication system as herein described. The wireless device 902 may be, for example, a UE of a wireless communication system. The network device 920 may be, for example, a base station (e.g., an eNB or a gNB) or a radio head of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 (also collectively referred to as a transceiver 910) that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs. In one or more embodiments, the antenna(s) 912 support mechanical beam steering, electronic beam steering, or both. The antenna(s) 912 may be or include directional antenna(s) (e.g., parabolic antennas), antenna array(s) (e.g., grids of phased antenna array elements), or other elements or features to direct the energy of transmitted electromagnetic radiation or improve the reception of received electromagnetic radiation, or a combination of these.

The wireless device 902 may include one or more antenna(s) 912 (e.g., one, two, four, eight, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi-user MIMO (MU-MIMO) methods (where individual data streams may be directed to individual (different) receivers in different locations in the spatial domain).

In some embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 916. The interface(s) 916 may be used to provide input to or output from the wireless device 902. For example, a wireless device 902 that is a UE may include interface(s) 916 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include measurement timing configuration manager 918. The measurement timing configuration manager 918 may be implemented via hardware, software, or combinations thereof. For example, the measurement timing configuration manager 918 may be implemented as a processor, circuit, and/or instructions 908 stored in the memory 906 and executed by the processor(s) 904. In some examples, the measurement timing configuration manager 918 may be integrated within the processor(s) 904 and/or the transceiver(s) 910. For example, the measurement timing configuration manager 918 may be implemented by a combination of software components (e.g., executed by a DSP or a general processor) and hardware components (e.g., logic gates and circuitry) within the processor(s) 904 or the transceiver(s) 910.

The measurement timing configuration manager 918 may be used for various aspects of the present disclosure, for example, aspects of FIGS. 1-9, from a wireless device or UE perspective. The measurement timing configuration manager 918 may be configured to, for example, cause the wireless device 902 to receive, via the transceiver(s) 910, control signaling indicating a first measurement gap configuration for the wireless device 902 that is associated with mechanical beam steering for the antenna(s) 912 different from a second measurement gap configuration associated with electronic beam steering. The measurement timing configuration manager 918 may be further configured to, for example, cause the wireless device 902 to communicate, via the antenna(s) 912 that is mechanically pointing toward a first direction, with a first non-terrestrial network device (e.g., NTN device 940) on a first radio frequency spectrum band. The UE does not expect to communicate with the first non-terrestrial network device during a restriction time window within the set of measurement time windows, the restriction time window including a set of time resources that are based at least in part on time resources for the signals that are indicated by the measurement timing configuration and one or more symbols for a switching time for mechanical beam steering of the antenna(s) 912. The measurement timing configuration manager 918 may be further configured to, for example, cause the wireless device 902 to perform, according to the measurement timing configuration and while the antenna(s) 912 is mechanically pointing toward at least a second direction, one or more measurements of the signals received via the antenna(s) 912 and the transceiver(s) 910.

In one or more embodiments, the set of time resources of the restriction time window comprises, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols.

In one or more embodiments, the set of time resources of the restriction time window includes, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols.

In one or more embodiments, the measurement timing configuration manager 918 may be further configured to determine the set of time resources of the restriction time window based at least in part on whether the first non-terrestrial network device is synchronized within a threshold value to a second non-terrestrial network device associated with the one or more measurements. In some embodiments, based at least in part on the first non-terrestrial network device being synchronized within the threshold value to the second non-terrestrial network device, the set of time resources of the restriction time window comprises, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols. In some embodiments, based at least in part on the first non-terrestrial network device being synchronized within the threshold value to the second non-terrestrial network device, the set of time resources of the restriction time window includes, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols. In some embodiments, based at least in part on the first non-terrestrial network device not being synchronized within the threshold value to the second non-terrestrial network device, the set of time resources of the restriction time window includes for each set of consecutive symbols for the signals to be measured, the one or more symbols for the switching time before the set of consecutive symbols, the set of consecutive symbols, and the one or more symbols for the switching time after the set of consecutive symbols.

In one or more embodiments, the measurement timing configuration manager 918 may be further configured to determine the set of time resources of the restriction time window based at least in part on whether the first non-terrestrial network device is within a same beam steering range for the antenna as a second non-terrestrial network device associated with the one or more measurements. In some embodiments, the measurement timing configuration manager 918 may be further configured to determine the set of time resources of the restriction time window further based at least in part on whether the first non-terrestrial network device uses a same numerology as the second non-terrestrial network device.

In one or more embodiments, a receive beam sweeping factor for the one or more measurements is one, regardless of whether a resource set configuration for a channel state information reference signal indicates for the UE to use repetition.

In one or more embodiments, a receive beam sweeping factor for the one or more measurements is based at least in part on whether the UE switches the antenna to mechanically point toward the second direction. In some embodiments, a receive beam sweeping factor for the one or more measurements is based at least in part on a quantity of channel state information reference signal resources in a resource set, the switching time for the mechanical beam steering, and a quantity of receive beams for a beam sweep.

In one or more embodiments, the measurement timing configuration manager 918 may be further configured to perform at least a first receive beam sweep using the mechanical beam steering and a second receive beam sweep using an electronic beam steering. In some embodiments, a receive beam sweeping factor for the one or more measurements is based at least in part on a quantity of channel state information reference signal resources in a resource set, the switching time for the mechanical beam steering, a first quantity of receive beams for the first receive beam sweep with mechanical beam steering, and a second quantity of receive beams for the second receive beam sweep with electronic beam steering.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 (also collectively referred to as a transceiver 928) that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 of a RAN (e.g., a base station, a radio head, etc.) may include interface(s) 932 made up of transmitters, receivers, and other circuitry (e.g., other than the transceiver(s) 928/antenna(s) 930 already described) that enables the network device 920 to communicate with other equipment in a network, and/or that enables the network device 920 to communicate with external networks, computers, databases, and the like for purposes of operations, administration, and maintenance of the network device 920 or other equipment operably connected thereto.

The network device 920 may include at least one measurement timing configuration manager 934. The measurement timing configuration manager 934 may be implemented via hardware, software, or combinations thereof. For example, the measurement timing configuration manager 934 may be implemented as a processor, circuit, and/or instructions 926 stored in the memory 924 and executed by the processor(s) 922. In some examples, the measurement timing configuration manager 934 may be integrated within the processor(s) 922 and/or the transceiver(s) 928. For example, the measurement timing configuration manager 934 may be implemented by a combination of software components (e.g., executed by a DSP or a general processor) and hardware components (e.g., logic gates and circuitry) within the processor(s) 922 or the transceiver(s) 928.

The measurement timing configuration manager 934 may be used for various aspects of the present disclosure, for example, aspects of FIGS. 1-9, from a network device perspective. The measurement timing configuration manager 934 may be configured to, for example, to cause the network device 920 or NTN device 940 to transmit (e.g., via the transceiver(s) 928), control signaling indicating a measurement timing configuration for the wireless device 902 to perform one or more measurements of signals from neighboring non-terrestrial network devices during a set of measurement time windows. The measurement timing configuration manager 934 may be further configured to, for example, to cause the network device 920 or NTN device 940 to communicate with the wireless device 902 on a first radio frequency spectrum band, where the wireless device 902 does not expect to communicate with the network device during a restriction time window within the set of measurement time windows, the restriction time window comprising a set of time resources that are based at least in part on time resources for the signals that are indicated by the measurement timing configuration and one or more symbols for a switching time for mechanical beam steering of an antenna at the wireless device 902.

In one or more embodiments, the set of time resources of the restriction time window includes, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols.

In one or more embodiments, the set of time resources of the restriction time window includes, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols.

The measurement timing configuration manager 934 may be configured to, for example, to cause the network device 920 or NIN device 940 to determine the set of time resources of the restriction time window based at least in part on whether the first non-terrestrial network device is synchronized within a threshold value to a second non-terrestrial network device associated with the one or more measurements.

In one or more embodiments, the measurement timing configuration manager 934 may be further configured to determine the set of time resources of the restriction time window based at least in part on whether the first non-terrestrial network device is within a same beam steering range for the antenna as a second non-terrestrial network device associated with the one or more measurements.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein but may be modified within the scope and equivalents of the appended claims.

1. A user equipment (UE), comprising:
a transceiver;
an antenna that is mechanically steerable by the UE and coupled with the transceiver; and
a processor configured to cause the UE to,
receive, via the transceiver, control signaling indicating a measurement timing configuration for the UE to perform one or more measurements of signals from neighboring non-terrestrial network devices during a set of measurement time windows,
communicate, via the antenna that is mechanically pointing toward a first direction, with a first non-terrestrial network device on a first radio frequency spectrum band, wherein the UE does not expect to communicate with the first non-terrestrial network device during a restriction time window within the set of measurement time windows, the restriction time window comprising a set of time resources that are based at least in part on time resources for the signals that are indicated by the measurement timing configuration and one or more symbols for a switching time for mechanical beam steering of the antenna, and
perform, according to the measurement timing configuration and while the antenna is mechanically pointing toward at least a second direction, one or more measurements of the signals received via the antenna and the transceiver.

2. The UE of claim 1, wherein the set of time resources of the restriction time window comprises, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols.

3. The UE of claim 1, wherein the set of time resources of the restriction time window comprises, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols.

4. The UE of claim 1, wherein the processor is further configured to cause the UE to:
determine the set of time resources of the restriction time window based at least in part on whether the first non-terrestrial network device is synchronized within a threshold value to a second non-terrestrial network device associated with the one or more measurements.

5. The UE of claim 4, wherein, based at least in part on the first non-terrestrial network device being synchronized within the threshold value to the second non-terrestrial network device,
the set of time resources of the restriction time window comprises, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols, or
the set of time resources of the restriction time window comprises, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols.

6. The UE of claim 4, wherein, based at least in part on the first non-terrestrial network device not being synchronized within the threshold value to the second non-terrestrial network device,
the set of time resources of the restriction time window comprises for each set of consecutive symbols for the signals to be measured, the one or more symbols for the switching time before the set of consecutive symbols, the set of consecutive symbols, and the one or more symbols for the switching time after the set of consecutive symbols.

7. The UE of claim 1, wherein the processor is further configured to cause the UE to:
determine the set of time resources of the restriction time window based at least in part on whether the first non-terrestrial network device is within a same beam steering range for the antenna as a second non-terrestrial network device associated with the one or more measurements.

8. The UE of claim 7, wherein the processor is further configured to cause the UE to:
determine the set of time resources of the restriction time window further based at least in part on whether the first non-terrestrial network device uses a same numerology as the second non-terrestrial network device.

9. The UE of claim 1, wherein a receive beam sweeping factor for the one or more measurements is one, regardless of whether a resource set configuration for a channel state information reference signal indicates for the UE to use repetition.

10. The UE of claim 1, wherein a receive beam sweeping factor for the one or more measurements is based at least in part on whether the UE switches the antenna to mechanically point toward the second direction.

11. The UE of claim 10, wherein a receive beam sweeping factor for the one or more measurements is based at least in part on a quantity of channel state information reference signal resources in a resource set, the switching time for the mechanical beam steering, and a quantity of receive beams for a beam sweep.

12. The UE of claim 1, wherein the processor configured to perform the one or more measurements comprises the processor configured to cause the UE to:
perform at least a first receive beam sweep using the mechanical beam steering and a second receive beam sweep using an electronic beam steering.

13. The UE of claim 12, a receive beam sweeping factor for the one or more measurements is based at least in part on a quantity of channel state information reference signal resources in a resource set, the switching time for the mechanical beam steering, a first quantity of receive beams for the first receive beam sweep with mechanical beam steering, and a second quantity of receive beams for the second receive beam sweep with electronic beam steering.

14. A network device, comprising:
a transceiver; and
a processor configured to cause the network device to,
transmit, via the transceiver, control signaling indicating a measurement timing configuration for a user equipment (UE) to perform one or more measurements of signals from neighboring non-terrestrial network devices during a set of measurement time windows, and
communicate with the UE on a first radio frequency spectrum band, wherein the UE does not expect to communicate with the network device during a restriction time window within the set of measurement time windows, the restriction time window comprising a set of time resources that are based at least in part on time resources for the signals that are indicated by the measurement timing configuration and one or more symbols for a switching time for mechanical beam steering of an antenna at the UE.

15. The UE of claim 14, wherein the set of time resources of the restriction time window comprises, for each set of consecutive symbols for the signals to be measured, one symbol and the one or more symbols for the switching time before the set of consecutive symbols, the set of consecutive symbols, and one symbol and the one or more symbols for the switching time after the set of consecutive symbols.

16. The UE of claim 14, wherein the set of time resources of the restriction time window comprises, for each set of consecutive symbols for the signals to be measured, a maximum of one symbol or the one or more symbols for the switching time before the set of consecutive symbols, the set of consecutive symbols, and the maximum of the one symbol or the one or more symbols for the switching time after the set of consecutive symbols.

17. The UE of claim 14, wherein the processor is further configured to cause the UE to:
determine the set of time resources of the restriction time window based at least in part on whether the first non-terrestrial network device is synchronized within a threshold value to a second non-terrestrial network device associated with the one or more measurements.

18. The UE of claim 14, wherein the processor is further configured to cause the UE to:
determine the set of time resources of the restriction time window based at least in part on whether the first non-terrestrial network device is within a same beam steering range for the antenna as a second non-terrestrial network device associated with the one or more measurements.

19. A method of wireless communication at a user equipment (UE), comprising:
receiving control signaling indicating a measurement timing configuration for the UE to perform one or more measurements of signals from neighboring non-terrestrial network devices during a set of measurement time windows;
communicating, via an antenna of the UE that is mechanically steerable by the UE and mechanically pointing toward a first direction, with a first non-terrestrial network device on a first radio frequency spectrum band, wherein the UE does not expect to communicate with the first non-terrestrial network device during a restriction time window within the set of measurement time windows, the restriction time window comprising a set of time resources that are based at least in part on time resources for the signals that are indicated by the measurement timing configuration and one or more symbols for a switching time for mechanical beam steering of the antenna, and
performing, according to the measurement timing configuration and while the antenna is mechanically pointing toward at least a second direction, one or more measurements of the signals received via the antenna.
